(19) United States
(12) Patent Application Publication
(10) Pub. No.: US 2013/0000502 A1
(43) Pub. Date: Jan. 3, 2013

(54) VALVE FOR FOUNTAIN SOLUTION

(75) Inventors: Birger Hansson, Akarp (SE); Michael Ridell, Staffanstorp (SE); Giorgio Sirianni, Milan (IT); Jacob Van Der Meijden, Hoeven (NL)

(73) Assignees: FLOCONTROL S.R.L., Peschiera Borromeo (Milan) (IT); BALDWIN JIMEK AB, Arlov (SE)

(21) Appl. No.: 13/635,527

(22) PCT Filed: Mar. 18, 2011
(86) PCT No.: PCT/SE2011/050301

§ 371 Date: Sep. 17, 2012

(30) Foreign Application Priority Data
Mar. 19, 2010 (SE) 1050262-3

(51) Int. Cl. B41F 31/02; F16K 31/02

(52) U.S. Cl. 101/364; 251/129.01

(57) ABSTRACT

An electromagnetic valve (100) for controlling flow of a pressurized liquid, comprises a plunger (110), which is able to move from a closed, downstream position, in which an end of the plunger (110) contacts a valve seat (120), to an open upstream position, in which the plunger (110) does not contact the valve seat (120). Hence an opening is left open for fluid flow, wherein the movement of the plunger to the open position is controlled by energizing a first coil (140). A second coil (130) arranged to pull the plunger (110) towards the closed position upon energizing.

### FIELD OF THE INVENTION

The present invention relates to an electromagnetic valve for controlling a flow of pressurized liquid, said valve comprising a plunger, which is able to move from a closed, downstream position, in which it contacts a valve seat, to an open upstream position, in which the valve does not contact the valve seat and hence leaves an opening open for fluid flow, wherein the movement of the plunger to the open position is controlled by energizing a first coil.

### PRIOR ART

In the art of electromagnetic valves for controlling a flow of liquid, electro-magnetic valves have been used for a long time. Such valves generally comprise a plunger, which cooperates with a valve seat in order to stop the liquid from passing the valve seat. A spring biases the plunger to a position where it seals the flow of liquid, i.e. is seated against the valve seat, and a magnetic field emanating from a current through a coil can pull the plunger from the sealing contact with the seat.

In DE 10 2007 052 022 A1, an actuator device for a separate valve is disclosed; the actuator device comprises an anchor, which is placed within a coil. By energizing the coil, the anchor is moved from a first position to a second position. A spring urges the anchor towards the first position. Moreover, the anchor is connected to a holding plate, which is placed between two holding coils. Once the anchor has reached the first or second position, it is possible to hold the anchor in this position by energizing either of the holding coils.

Electromagnetic valves of the known type have many beneficial properties, but they also have some drawbacks concerning the opening delay (i.e. the time from which a voltage is applied to the coil until the plunger is lifted from the seat), individual-to-individual variations, and wear due to too fast seating of the plunger at valve closure.

The benefits of electromagnetic valves of the known type are basically that they are cost efficient and that they are closed in the case of power failure, due to the sprig urging the plunger against the seat.

The purpose of the present invention is to provide a valve enabling a more rapid opening (i.e. shorter time from application of voltage to the coil till opening of the valve), less individual-to-individual variation and a soft closure.

A valve according to the invention may e.g. be used for supplying fountain solution to a printing press.

### SUMMARY OF THE INVENTION

These and other problems are solved by a valve comprising a second coil, which upon energizing urges the plunger to the closed position.

In order to ensure good tightness and a smooth seating during closing, the end of the plunger contacting the valve seat may be provided with a conical surface.

In order to further soften the seating of the plunger, the conical surface may be surrounded by a circular flat surface.

In order to be able to control the opening of the valve, a sensor sensing whether the plunger is in its closing position or its open position may be provided.

In order to allow fluid flow through the valve, the plunger may be provided with a recess or opening for allowing pressurized fluid to pass the plunger.

An example of an advantageous use of an electromagnetic valve according to the invention is for a supplier of fountain solution to a printing press.

### BRIEF DESCRIPTION OF THE DRAWINGS

Hereinafter, the invention will be described with reference to the appended drawings, wherein:

FIG. 1 is a schematic view showing a basic design of a valve according to the present invention, and

FIG. 2 is a schematic view of a valve according to the invention, which shows more details.

### DESCRIPTION OF EMBODIMENTS

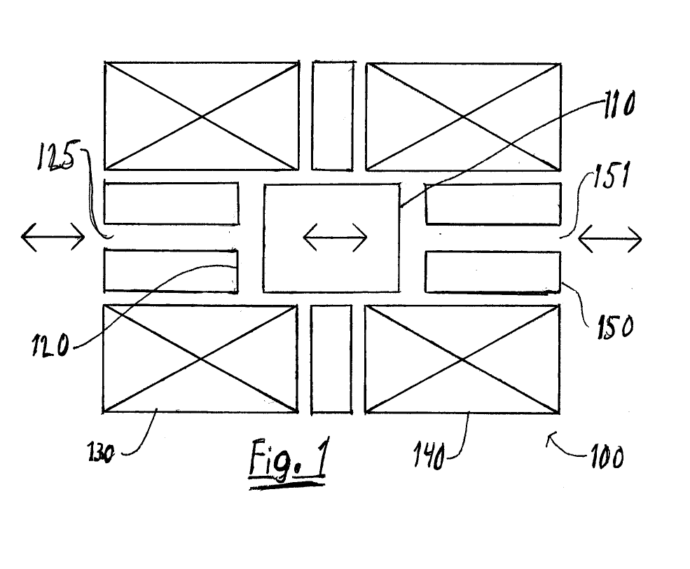

In FIG. 1, a first embodiment of a valve 100 according to the invention is shown. The valve 100 comprises a plunger 110, which is movable from a closed position, wherein the plunger contacts a valve seat 120 provided with an opening 125, to an open position, wherein the plunger is removed from contact with the valve seat, such that the opening 125 is open for fluid flow.

The movement of the plunger is controlled by two coils 130, 140. By energizing the coil 130, the plunger is moved towards the valve seat 120, whereas by energizing the coil 140, the plunger is moved away from engagement with the valve seat 120.

The plunger, the valve seat 120 and an anchor 150, provided with an inlet 151 arranged on the opposite side of the plunger and provided with an inlet for pressurized fluid, are made from a magnetically conductive, i.e. magnetically “soft”, material, e.g. ferritic stainless alloy. The anchor 150 is provided with an opening for letting in fluid into the valve. Consequently, the plunger is surrounded by pressurized liquid in use. In order to allow the pressurized fluid to pass the plunger, it may be provided with a recess (not shown) extending from the anchor 150 end to the valve seat 120 end of the plunger 110.

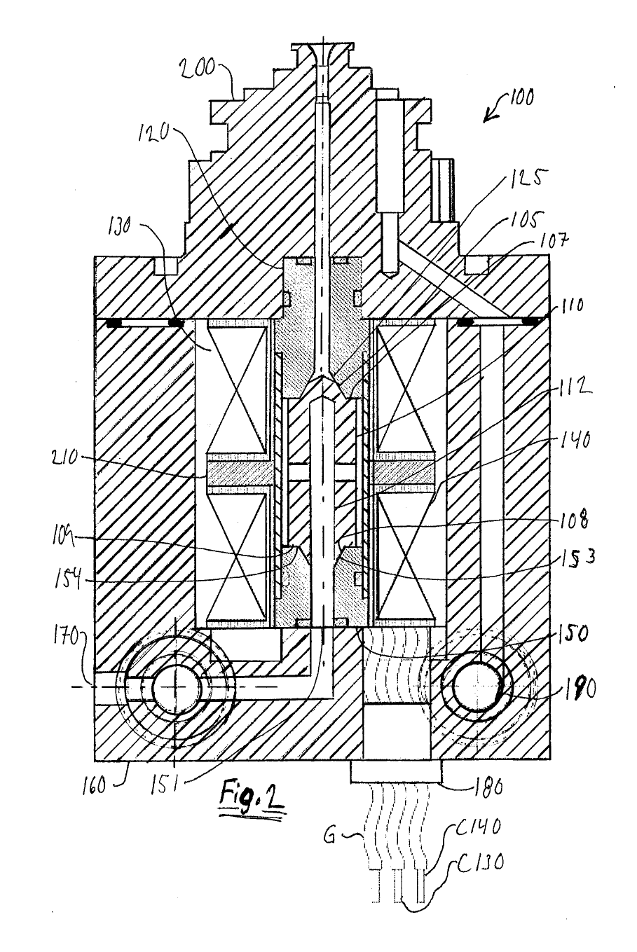

In FIG. 2, the valve of FIG. 1 is shown in greater detail. As can be seen in FIG. 2, the plunger 110 is provided with a conical end 105, which cooperates with a corresponding shape of the opening 125. Moreover, the plunger 110 is provided with a flat portion 107 surrounding the conical end, which flat portion cooperates with a corresponding flat portion of the valve seat. The purpose of the conical and flat portions of the plunger and the valve seat will be explained later.

On the opposite end of the valve seat, the plunger 110 and the anchor 150 are provided with corresponding conical surfaces 108, 153 and flat portions 109, 154 surrounding the inlet 151 of the anchor 150.

Moreover, the plunger 110 is provided with a conduit 112, which extends from the anchor 150 to a central portion of the plunger, from which position it extends to a circumference of the plunge.

The two coils 130, 140 partly surround the valve seat 120 and the anchor 150, respectively. As mentioned earlier, the valve seat and the anchor are made from a magnetically “soft” material, meaning that the material is easily magnetized. The plunger is also made from a material having equal properties.

The coils 130, 140, the valve seat 120, the anchor 150 and the plunger 110 are enclosed in a housing 160. The housing could be made from any non-magnetic material, e.g. plastic or aluminum. The housing 160 according to one embodiment comprises an inlet 170 for pressurized fluid, a cable opening 180 and an inlet 190 for pressurized air. The inlet 170 for pressurized fluid is connected to the inlet 151 of the anchor 150, whereas the opening 190 is connected to a socket 200 adapted for fitting of an air cap (not shown).

At least three control cables G, C130 and C140 are connected to the coils 130, 140. The cable G is a common ground cable connected to both coils 1300, 140, whereas the cable C130 is connected to the coil 130 and the cable C140 is connected to the coil 140.

In order to allow for a fluid flow through the valve 100, the coil 140 is energized by applying a voltage over the C140 cable and the common ground cable G. As well known in the art of electromagnetic coils, an application of a voltage over a coil does not immediate cause a current through the coil (and the current through the coil is what causes the desired electromagnetic field). However, once the necessary current has been reached, the plunger will be moved from contact with the opening of the valve seat 120 due to the magnetic field caused by the current in the coil. As mentioned, the anchor 150 is preferably made from an electromagnetically “soft” material, which will increase the strength of the magnetic field.

The magnetic field of the anchor 150 and the coil 140 will accelerate the plunger 110 towards the anchor 150. In order to reduce the impact of the plunger on the anchor, a voltage may be added to the coil 130 prior to the plunge contacting the anchor. A current through the coil 130 will decelerate the movement.

Moreover, the impact will be dampened du to the conical surface 108 and its counteracting surface 153 and the flat portions 109, 154. As could be understood, the space between such surfaces will be filled with fluid, and prior to impact, such fluid must be squeezed out. The squeezing of such fluid will slow down the plunger prior to impact.

Once the plunger has contacted the anchor 150, the current through the coil 140 may be reduced significantly. There are special circuits (so called “peak-and-hold” circuits) available for driving coils, e.g. for valves. Such circuitry will save electrical energy and reduce the emission of heat in the coil 140. “Peak-and-hold” circuitry may as well be used for the coil 130.

In order to close the valve 100, the current to the coil 140 is shut off; here, it is important to remember that if a current to a coil is rapidly shut off, a voltage over the coil may rapidly increase to very high levels. After the current to the coil 140 has been shut off, one can either wait until the plunger moves to a position wherein it contacts the valve seat 120, driven by the force of the pressurized fluid, or one can apply a voltage to the coil 130 to speed up the movement of the plunger to the seat 120.

In another embodiment of the invention, it is possible to achieve a very rapid opening or closing of the valve by the following method steps:

Applying a voltage over a first of the coils;

Applying a voltage over the second of the coils;

Holding the voltage over the second of the coils until a certain current through the second of the coils has been achieved; and

Closing the current to the first of the coils.

By the above method steps, a magnetic field urging the plunger towards the opposite position from its present location is achieved before it starts to travel when the current to the first of the coils is closed. It should be noted that the above method steps are possible for both opening and closing of the valve; the denotations first of the coils and the second of the coils have been used above in order for the description to cover both a closing sequence and an opening sequence.

The closure impact between the plunger and the valve seat is dampened in the same way as the impact between the plunger and the anchor at opening, i.e. by the squeezing of liquid between the conical surfaces 105 and the flat portions 107, and by optional energizing of the coil 140.

The design of the plunger and the valve seat will make the valve “self-closing”, once the plunger is seated on the valve seat, due to the pressure of the fluid. It is hence not necessary to energize the coil 130 once the plunger is seated on the valve seat.

Although the design of the valve will make the valve self-closing, energizing the coil 130 during closure of the valve will make the closure more rapid and predictable, hence increasing the preciseness of the opening time.

In some embodiments, the valve 100 may be provided with a sensor 210. This sensor may e.g. be a further coil sensing differences regarding inductance that emanate upon movement of the plunger, or an optical sensor sensing movement of the plunger. The signal from the optional sensor 210 may be used to control the current to the coils 130, 140 (for example, it might be used such that the voltage application to the coil is maintained until the plunger starts moving, after which the voltage application is replaced by a holding current).

As can be understood, there are many modifications possible to the valve 100 as it has been described above without departing from the scope of the invention, such as defined by the appended claims.

### Materials and Dimensions

In one embodiment, the plunger 110, the valve seat 120 and the anchor 150 are all manufactured from a ferritic stainless alloy. The coils 130, 140 may be wound 450 rounds from copper wire having a diameter of 0.280 mm. A diameter of the plunger may be e.g. 8 mm, and its length may be about 14 mm.

1. An electromagnetic valve (100) for controlling flow of a pressurized liquid, said valve (100) comprising a plunger (110), which is able to move from a closed, downstream position, in which an end of the plunger (110) contacts a valve seat (120), to an open upstream position, in which the plunger (110) does not contact the valve seat (120) and hence leaves an opening open for fluid flow, wherein the movement of the plunger to the open position is controlled by energizing a first coil (140), characterized by a second coil (130) arranged to pull the plunger (110) towards the closed position upon energizing.

2. The electromagnetic valve (100) according to claim 1, wherein the end of the plunger contacting the valve seat is provided with a conical surface (105).

3. The electromagnetic valve (100) according to claim 2, wherein the conical surface (105) is surrounded by a circular flat surface (107).

4. The electromagnetic valve (100) according to claim 1, further comprising a sensor (210) sensing whether the plunger is in its closing position or its open position.

5. The electromagnetic valve (100) according to claim 1, wherein the plunger is provided with an internal conduit that communicates with the circumference of the plunger.

6. A printing press having an electromagnetic valve according to claim 1, wherein the valve is configured to supply fountain solution to the printing press.
